(19) United States
(12) Patent Application Publication
(10) Pub. No.: US 2025/0310140 A1
(43) Pub. Date: Oct. 2, 2025

(54) ATTENTION BASED CAMERA SELECTION

(71) Applicant: Lenovo (Singapore) Pte. Ltd., Singapore (SG)

(72) Inventors: Lincoln Penn Hancock, Raleigh, NC (US); Ellis Anderson, Greensboro, NC (US); Jeffrey E. Skinner, Raleigh, NC (US)

(21) Appl. No.: 18/622,626

(22) Filed: Mar. 29, 2024

(51) Int. Cl. H04L 12/18; G06V 40/10

(52) U.S. Cl. CPC H04L 12/1822; G06V 40/10; H04L 12/1827

(57) ABSTRACT

A computer implemented method includes detecting an attention direction of a local participant in an electronic meeting using an attention detector, selecting one of multiple local cameras to capture images of the local participant having a position most closely associated with the detected attention direction, and transmitting images from the selected one of the multiple cameras to remote participant devices. A gallery view may also be displayed on a display situated near the direction of attention.

### BACKGROUND

Common meeting room setups typically feature a large wall-mounted display with a camera mounted above or below. This may be suitable when remote attendees appear on that screen and in-room attendees' attention is directed there. However, when conversation moves to a table or activity moves to a different part of the room, remote attendees can feel (and truly be) left out of the meeting. Solutions such as 360° center-of-table cameras seek to address this challenge by bringing the remote person's point of view to the table.

### SUMMARY

A computer implemented method includes detecting an attention direction of a local participant in an electronic meeting using an attention detector, selecting one of multiple local cameras to capture images of the local participant having a position most closely associated with the detected attention direction, and transmitting images from the selected one of the multiple cameras to remote participant devices. A gallery view may also be displayed on a display situated near the direction of attention.

### BRIEF DESCRIPTION OF THE DRAWINGS

FIG. 1 is an overhead block representation of a meeting room having multiple cameras for selection according to an example embodiment.

FIG. 2 is an overhead block representation of an alternative meeting room having multiple cameras for selection according to an example embodiment.

FIG. 3 is an overhead view representation of meeting room where participant attention is directed towards a first device according to an example embodiment.

FIG. 4 is a perspective view of a meeting room having a white board being used or a display showing a presentation according to an example embodiment.

FIG. 5 is a view of a system for controlling capture of images or video, display of participants, and transmission of images or video to remote participants according to an example embodiment.

FIG. 6 is a flowchart illustrating a computer implemented method of camera or image selection based on attention according to an example embodiment.

FIG. 7 is a flowchart illustrating a computer implemented method of detecting the attention direction of a local participant in an electronic meeting according to an example embodiment.

FIG. 8 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

Common meeting room setups typically feature a large wall-mounted display with a camera mounted above or below. This may be suitable when remote attendees appear on that screen and in-room attendees' attention is directed there. However, when conversation moves to a table or activity moves to a different part of the room, remote attendees can feel (and truly be) left out of the meeting. Solutions such as 360° center-of-table cameras seek to address this challenge by bringing the remote person's point of view to the table.

Pan, tilt, and zoom (PTZ) and multi-camera solutions also focus on improving point of view. These solutions solve only part of the problem. Even when remote attendees have better views of the room, in-room participants will continue to look to the front-of-room display. If the remote persons' point of view is not from that screen, then they will continue to feel they are not being directly addressed.

An improved hybrid meeting system determines where local participants have their attention directed to determine a local camera to use to capture images of the local attendees in a meeting room. As attention shifts, a different local camera may be used to capture images of the local attendees once the attention is directed more towards the different local camera. The captured images are transmitted to remote participants for display to provide an intelligent representation of the meeting. By capturing images based on attention, remote users see more of the front and face of local participants, providing an improved sense of inclusion in a hybrid meeting.

The meeting system may include multiple screens or displays in the meeting room. Multi-screen setups may include the ability to display a video gallery of multiple participants on different screens in different locations in the room, including (but not limited to) center-of-table, head-of-table, and wall-mounted displays. The meeting system leverages one or more of computer vision, gaze detection and eye tracking to assess type of activity, physical posture, and direction of attention of in-room participants in the hybrid meeting, to make a determination about where to display the video gallery.

The meeting system may use information from multiple cameras in the room to determine which camera feed is most optimal to broadcast in order to create the best experience for remote participants. In situations where the video gallery may appear in different places at different times, the meeting system provides a way for a meeting videoconferencing solution to make an intelligent decision about which camera provides the best view.

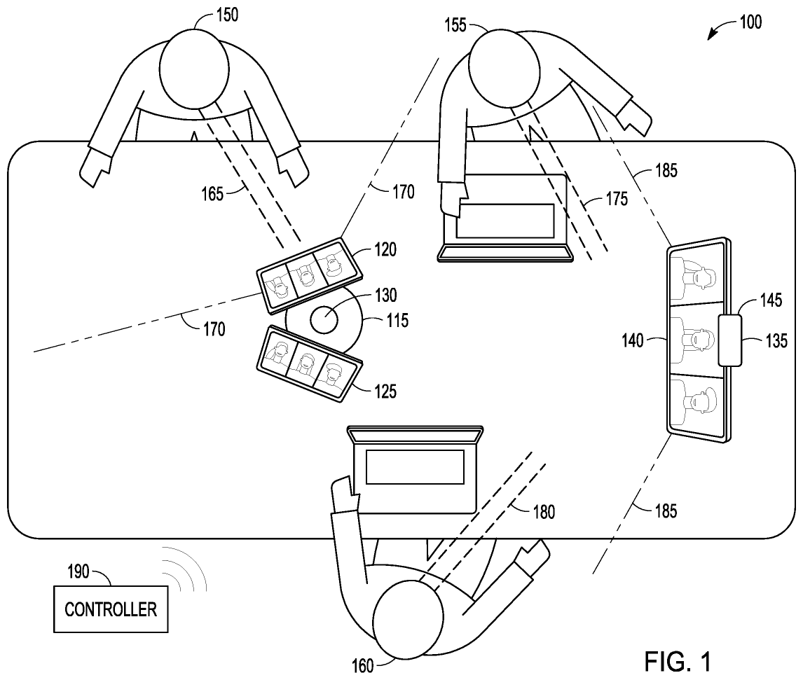

FIG. 1 is an overhead block representation of a meeting room 100 that includes a meeting table 110. The meeting room 100 may include walls or may even be an open space in various examples. A first device 115 is located near a middle of the table 110 and includes one or more displays 120 and 125 as well as a first camera 130. First camera 130 may include several cameras to capture view of the room including a 360-degree field of view.

A second device 135 may be located near a head of the table 110 and includes a display 140 and a second camera 145 positioned to capture a view of the table including one or more local participants 150, 155, 160 shown sitting around the table and optionally other participants not sitting near the table.

Each local participant is show with a representation of where their attention is located. Participant 150 has an attention 165 directed toward the first device 115. The first camera 130 has a field of view indicated by field of view 170 that includes a view of participant 150. Participants 155 and 160 have corresponding attentions 175 and 180 directed toward the second camera 140 having a field of view 185 that includes participants 155 and 160.

In one example, the imaged captured by one or both of first device 115 and second device 135 may be received and processed by a meeting controller 190 to determine attention direction. One or both of first device 115 and second device 135 may include the meeting controller 190 in further examples. Attention direction may be determined individually for each participant. For example, as shown, Participant 150 has both body position and gaze directed toward the first device 115. Alternatively, participant 150 may be speaking or otherwise carrying on a conversation used to determine attention direction.

Participants 155 and 160 both have body position and gaze directed toward the second device 135. Participants 155 and 160 may alternatively be having a conversation, causing attention being determined as more directed toward the second device 135 than the first device 115.

Each of the displays 120, 140 and 145 include a gallery view of remote participants. Since local participants have attention split between first device 115 and second device 135, the displays are all showing the gallery view. The gallery view displayed locally may include views from both one or more local cameras and remote cameras or even just show views of the local and remote participants that are actively engaged in conversation in various user selectable modes.

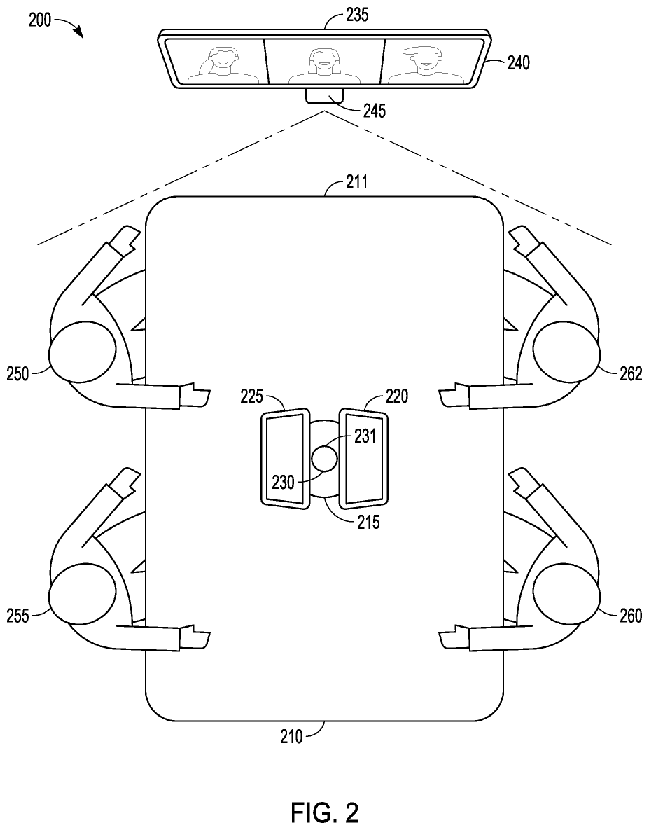

FIG. 2 is an overhead block representation of an alternative meeting room 200 configuration that includes a meeting table 210 having a table head 211. A first device 215 is located near a middle of the table 210 and includes one or more displays 220 and 225 as well as a first cameras 230 and 231.

A second device 235 may be a wall mounted device located near the table head 211 and includes a display 240 and a second camera 245 positioned to capture a view of the table including one or more local participants 250, 255, 260, and 262 shown sitting around the table and optionally other participants not sitting near the table.

Each local participant is shown with their attention directed more towards the wall mounted second device 235. A conversation may be directed towards the table head 211 as evidenced by the body position of each participant being tilted towards the head of the table 210. Display 240 shows a gallery view of at least remote meeting participants, and a view captured by the second camera 245 is being transmitted to remote participants.

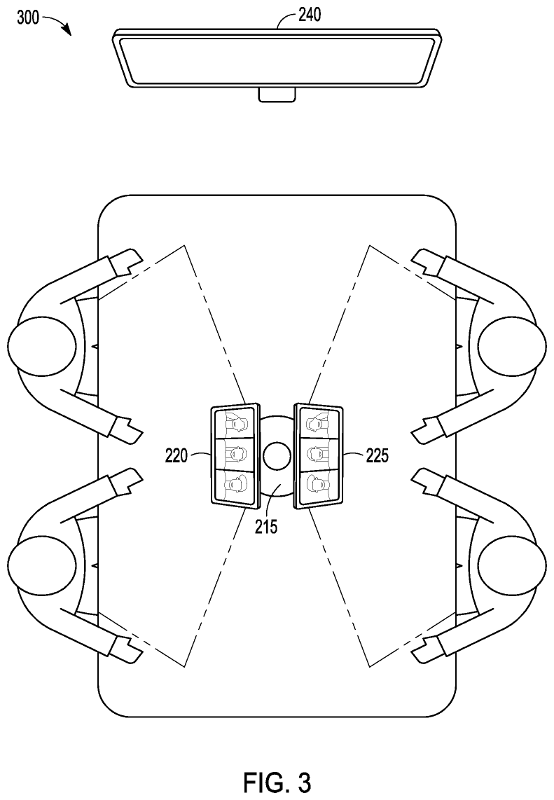

FIG. 3 is an overhead view representation 300 of meeting room 200 where participant attention is now directed towards the first device 215. The gallery view is now displayed on both the first device 215 displays 220 and 225. The change in display was made in response to the attention of the local participants either being drawn toward a conversation occurring around the table.

In further examples, additional devices with a camera and display may be positioned in the room or may be movable. One such additional device may be located opposite a wall-mounted display, or in another part of the room (such as near a whiteboard). The meeting system may automatically move the video gallery to the additional device display and activate the attached camera when and if it determines activity is oriented in its direction.

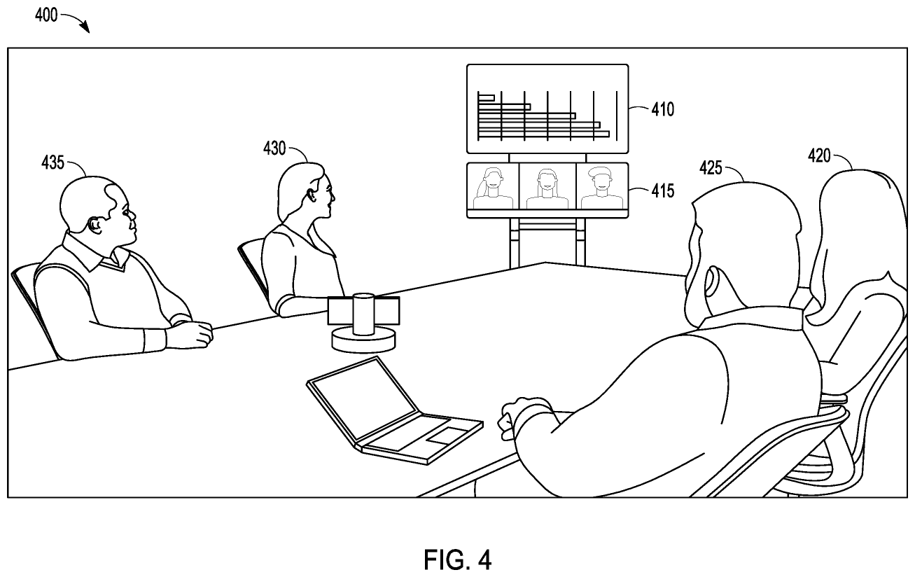

FIG. 4 is a perspective view of a meeting room 400 having a white board being used or a display 410 showing a presentation. A display 415 shows a gallery view of remote participants. The gallery view is displayed on display 415 in response to the presentation being selected for display on display 410 in one example. The system may be configured to interpret the selection of the presentation for display on display 410 as an indication of where attention of local participants is or should be directed. Each of four local participants 420, 425, 430, and 435 are shown has having their attention directed toward the display 410.

In a further example, the gallery view may be selected for display on display 415 in response to attention of the local participants being directed to the display 410. In one example, display 410 may also include a camera having the participants in its field of view for capture of video of the local participants whose attention is directed toward the display 410 either due to the presentation being displayed or perhaps due to another local participant being located and speaking near display 410. The captured video may be transmitted to remote participant devices. A further camera located where the speaker near display 410 may be speaking may be activated when the speaker is looking back toward the table to capture images of the speaker. The video transmitted to remote participant devices may include view of one or more of the speaker, the local participants, and the presentation being displayed.

In response to conversation occurring around the table, or visual attention being directed toward participants around the table, views from a device 440 that includes a display 445 and camera 450 may be captured and transmitted, with display 445 including the gallery view.

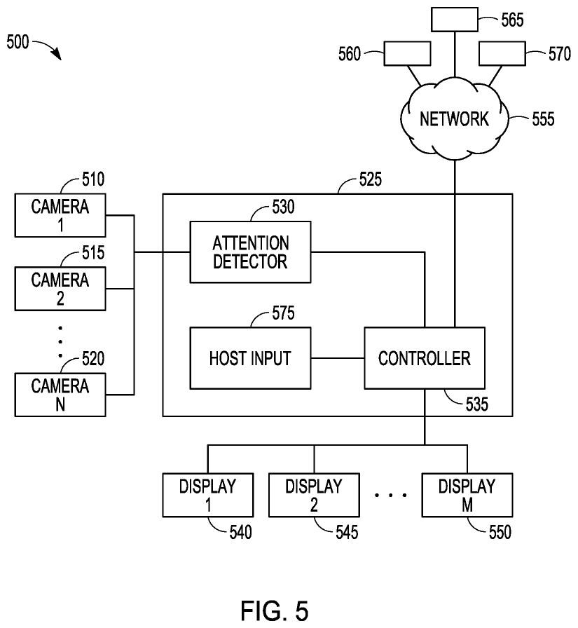

FIG. 5 is a view of a system 500 for controlling capture of images or video, display of participants, and transmission of images or video to remote participants. System 500 includes multiple cameras for positioning around a meeting room. Camera 1 510, camera 2 515, and camera N 520 are shown providing images, such as video, to a meeting controller 525. Meeting controller 525 includes an attention detector 530 that may include one or more trained models for determining a direction to which participants captured in the images is directed.

Gaze attention determination from an image involves analyzing visual cues to infer where a person is looking. In one example, computer vision techniques may be used and may include several steps.

A first step is to locate faces within a received image. Images from one or more of the cameras may be used. Example algorithms for performing face detection include Haar cascades, Histogram of Oriented Gradients (HOG), or deep learning models that have been trained to identify the human face within a variety of contexts and lighting conditions.

Once faces are detected, eye detection may be performed. Eye detection can be a subset of the face detection process, where the region of the face is further analyzed to locate the eyes. Algorithms may look for specific features such as the contrast between the sclera (white of the eye) and the iris or use landmark detection models to find the position of the eyes within the face.

With the eyes detected, gaze estimation algorithms analyze the position and orientation of the eyes to determine the direction of gaze. This can involve simple geometric models that consider the relative position of the iris within the eye socket, or more complex models that take into account the 3D orientation of the head and eyes.

The direction of gaze may also be influenced by the orientation of the head. Determining head pose can improve the accuracy of gaze attention analysis. Head pose can be performed by detecting facial landmarks and using the facial landmarks to infer a three-dimensional orientation of the head.

For a more refined analysis, some systems may also track movement of the pupils. Tracking movement of the pupils utilizes high-resolution images where the pupils are clearly visible. The increased accuracy provided by pupil tracking is likely not needed for typical meeting rooms where the number of cameras is likely limited and significantly radially spaced from participants. With closely spaced cameras and associated displays, pupil tracking can be used to provide an improved overall remote participant experience.

Gaze attention may be performed by combining multiple cues, including eye position, head pose, and even the context of a scene to infer where a person is looking.

In one example, the attention detector 530 perform gaze attention detection using machine learning models that have been trained on large datasets of labeled images. These models can automatically learn to recognize patterns associated with different gaze directions.

For precise applications, a calibration process may be used where the subject looks at known points on a screen or in the environment, allowing the system to more accurately interpret gaze direction relative to those points.

The output of gaze attention determination by attention detector 530 is provided to a controller 535 to determine which of several camera feeds to select in a multi-camera setup for a video conference. Gaze detection is used to assess the direction of attention of in-room participants and make corresponding decisions about camera selection and video gallery placement between M in room displays 540, 545, and 550. While N cameras and M displays are shown, N and M may be equal or different integers equal to or greater than two.

Controller 535 may also determine which images to transmit via network 555 to remote participant devices 560, 565, and 575. The number of remote devices may be one or more.

In one example, a meeting organizer may provide host input 575 which may also be used by controller 535 as an attention direction input, such as in the case of the organizing displaying a presentation on one or more of the displays.

Once the attention direction is detected, it is correlated to known positions of the cameras to select the camera that is closest to the attention direction. If images from all cameras are processed for attention direction, the camera providing the image with the smallest deviation in attention direction away from the camera may be selected. A 360-degree coordinate system such as a compass based North, East, South, West may be used to define the head of the table as North. Camera placement may be manually defined using the coordinate system. In further examples, image processing techniques may be used to identify devices that include a camera and a display to establish the location of such devices for correlation.

In one example, each local participant may have their own attention direction determined. In such a case, each local participant may have a camera selected to capture their images such that they appear to be paying attention towards the general direction of the selected camera. One or more local participants may have the same camera selected. The captured images of the local participants may be included in the transmission to remote participants for inclusion in a gallery view. In addition, a local gallery view of remote participants may be directed to a display near or included in a device having the selected camera.

In cases where a room view is to be provided to remote participants, the attention direction of all local participants may be averaged to select a camera for the room view to be provided to remote participants. While averaging may work in some examples, the camera corresponding to the attention of a majority of local participants may be used in further examples. In still further examples, a local participant that is presenting near a displayed presentation may be selected for controlling camera selection. If conversation switches to local participants sitting around a table having a discussion, one or more cameras neat the center of the table may be selected for providing one or more room views to be added to the transmitted gallery view.

For individual images of local participants, cropping may be performed to provide a typical headshot view based on face recognition similar to that described above as a first attention detection step. Background effects common in video conferencing may also be used, such as background blur if desired.

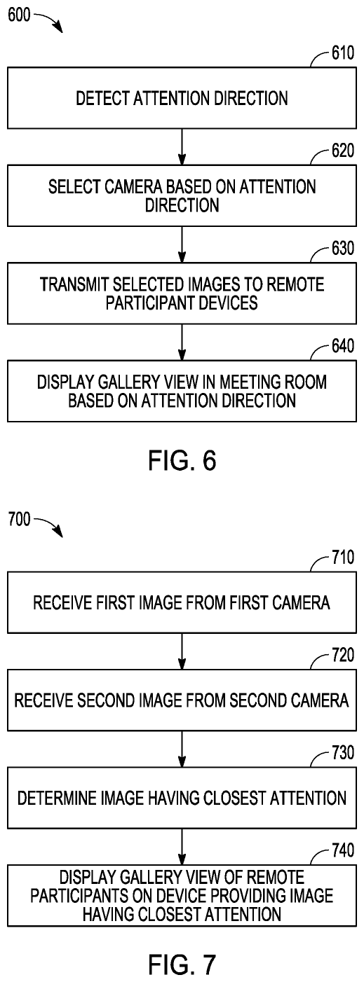

FIG. 6 is a flowchart illustrating a computer implemented method 600 of camera or image selection based on attention. Method 600 begins at operation 610 by detecting an attention direction of a local participant in an electronic meeting using an attention detector. Operation 620 selects one of multiple local cameras to capture images of the local participant having a position most closely associated with the detected attention direction. Images from the selected one of the multiple cameras are transmitted at operation 630 to remote participant devices.

In one example one of the multiple cameras capturing an image having a highest level of attention directed toward it is selected for transmission. Each camera may be part of a device with an associated display. Operation 640 displays a gallery view of attendees on the display of the device having the camera that providing the selected image.

FIG. 7 is a flowchart illustrating a computer implemented method 700 of detecting the attention direction of a local participant in an electronic meeting. Method 700 begins at operation 710 by receiving a first image from a first local camera of the multiple local cameras in the meeting room. A second image is received at operation 720 from a second local camera of the multiple local cameras in the meeting room. Operation 730 determines which of the first and second images to which attention of the local participant is most closely directed using the attention detector.

In one example, the second image is selected in response to the attention direction being more toward the second local camera than the first local camera for transmission to a remote participant device.

Method 700 may include displaying a gallery view of remote participants on a second local display associated with the second local camera at operation 740. In one example, the attention detector comprises a gaze detection system or a head position recognizer that detects head posture or position posture. In one example the first local camera comprises a table camera, the second local camera comprises a front of room camera, and the local participant comprises multiple local participants.

The attention direction may be determined based on a combination of attention direction of each of multiple local participants and may be selected based on an average or majority of attention directions of the multiple local participants or even based on a position in the room of one or more of the multiple local participants that are speaking.

In a further example the attention direction is determined as more toward the front of room camera in response to a presentation being made at the front of the room. The attention direction may alternatively be determined as more toward the table camera in response to a discussion occurring around the table.

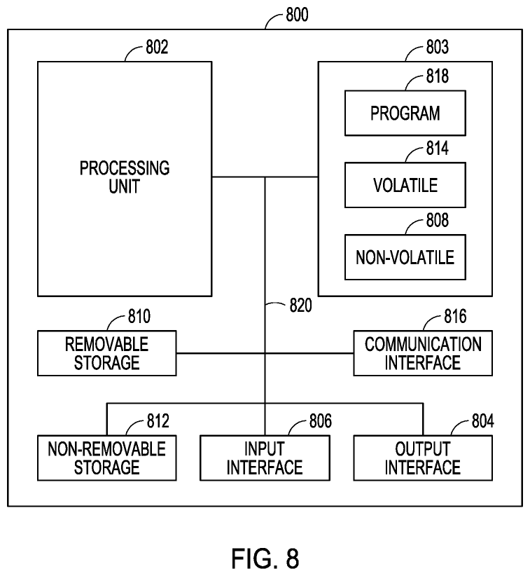

FIG. 8 is a block schematic diagram of a computer system 800 to capture images, perform attention direction detection, control camera feeds, control displays, and for performing methods and algorithms according to example embodiments. All components need not be used in various embodiments.

One example computing device in the form of a computer 800 may include a processing unit 802, memory 803, removable storage 810, and non-removable storage 812. Although the example computing device is illustrated and described as computer 800, the computing device may be in different forms in different embodiments. For example, the computing device may instead be a smartphone, a tablet, smartwatch, smart storage device (SSD), or other computing device including the same or similar elements as illustrated and described with regard to FIG. 8. Devices, such as smartphones, tablets, and smartwatches, are generally collectively referred to as mobile devices or user equipment.

Although the various data storage elements are illustrated as part of the computer 800, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 803 may include volatile memory 814 and non-volatile memory 808. Computer 800 may include—or have access to a computing environment that includes—a variety of computer-readable media, such as volatile memory 814 and non-volatile memory 808, removable storage 810 and non-removable storage 812. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 800 may include or have access to a computing environment that includes input interface 806, output interface 804, and a communication interface 816. Output interface 804 may include a display device, such as a touchscreen, that also may serve as an input device. The input interface 806 may include one or more of a touchscreen, touchpad, mouse, keyboard, camera, one or more device-specific buttons, one or more sensors integrated within or coupled via wired or wireless data connections to the computer 800, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 800 are connected with a system bus 820.

Computer-readable instructions stored on a computer-readable medium are executable by the processing unit 802 of the computer 800, such as a program 818. The program 818 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 818 along with the workspace manager 822 may be used to cause processing unit 802 to perform one or more methods or algorithms described herein.

### EXAMPLES

1. A computer implemented method includes detecting an attention direction of a local participant in an electronic meeting using an attention detector, selecting one of multiple local cameras to capture images of the local participant having a position most closely associated with the detected attention direction, and transmitting images from the selected one of the multiple cameras to remote participant devices.

2. The method of example 1 wherein detecting the attention direction of a local participant in an electronic meeting includes receiving a first image from a first local camera of the multiple local cameras in the meeting room, receiving a second image from a second local camera of the multiple local cameras in the meeting room, and determining which of the first and second images to which attention of the local participant is most closely directed using the attention detector.

3. The method of example 2 wherein the second image is selected in response to the attention direction being more toward the second local camera than the first local camera for transmission to a remote participant device.

4. The method of example 3 and further including displaying the second image on a second local display associated with the second local camera.

5. The method of any of examples 2-6 wherein the first local camera includes a table camera, the second local camera comprises a front of room camera, and the local participant comprises multiple local participants.

6. The method of example 5 wherein the attention direction is determined based on a combination of attention direction of each of multiple local participants.

7. The method of example 6 wherein the combination is based on an average or majority of attention directions of the multiple local participants.

8. The method of any of examples 5-7 wherein the attention direction is based on a position in the room of one or more of the multiple local participants that are speaking.

9. The method of any of examples 5-8 wherein the attention direction is determined as more toward the front of room camera in response to a presentation being made at the front of the room.

10. The method of any of examples 5-9 wherein the attention direction is determined as more toward the table camera in response to a discussion occurring around the table.

11. The method of any of examples 1-10 wherein the attention detector includes a gaze detection system.

12 The method of any of examples 1-11 wherein the attention detector includes a head position recognizer that detects head posture or position posture.

13. The method of any of examples 1-12 wherein one of the multiple cameras capturing an image having a highest level of attention directed toward it is selected for transmission.

14. The method of any of examples 1-13 wherein each camera is part of a device with an associated display.

15. The method of example 14 and further including displaying a gallery view of attendees on the display of the device providing the selected image.

16. A machine-readable storage device has instructions for execution by a processor of a machine to cause the processor to perform operations to perform any of the method of examples 1-15.

17. A device includes a processor and a memory device coupled to the processor and having a program stored thereon for execution by the processor to perform any of the method of examples 1-15.

18. A computer implemented method including detecting an attention direction of a local participant in an electronic meeting using an attention detector, receiving images of remote participants, selecting one of multiple local displays for display of at least one of the images of the remote participants, the selected local display having a position most closely associated with the detected attention direction, and displaying that at least one of the images of remote participants on the selected local display.

19. The method of example 18 wherein multiple images of the remote participants are displayed in a gallery view on the selected local display.

20. A machine-readable storage device has instructions for execution by a processor of a machine to cause the processor to perform operations to perform any of the method of examples 18-19.

21. A device includes a processor and a memory device coupled to the processor and having a program stored thereon for execution by the processor to perform any of the method of examples 18-19.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
detecting an attention direction of a local participant in an electronic meeting using an attention detector;
selecting one of multiple local cameras to capture images of the local participant having a position most closely associated with the detected attention direction; and
transmitting images from the selected one of the multiple cameras to remote participant devices.

2. The method of claim 1 wherein detecting the attention direction of a local participant in an electronic meeting comprises:
receiving a first image from a first local camera of the multiple local cameras in the meeting room;
receiving a second image from a second local camera of the multiple local cameras in the meeting room; and
determining which of the first and second images to which attention of the local participant is most closely directed using the attention detector.

3. The method of claim 2 wherein the second image is selected in response to the attention direction being more toward the second local camera than the first local camera for transmission to a remote participant device.

4. The method of claim 3 and further comprising displaying the second image on a second local display associated with the second local camera.

5. The method of claim 2 wherein the first local camera comprises a table camera, the second local camera comprises a front of room camera, and the local participant comprises multiple local participants.

6. The method of claim 5 wherein the attention direction is determined based on a combination of attention direction of each of multiple local participants.

7. The method of claim 7 wherein the combination is based on an average or majority of attention directions of the multiple local participants.

8. The method of claim 5 wherein the attention direction is based on a position in the room of one or more of the multiple local participants that are speaking.

9. The method of claim 5 wherein the attention direction is determined as more toward the front of room camera in response to a presentation being made at the front of the room.

10. The method of claim 5 wherein the attention direction is determined as more toward the table camera in response to a discussion occurring around the table.

11. The method of claim 1 wherein the attention detector comprises a gaze detection system.

12. The method of claim 1 wherein the attention detector comprises a head position recognizer that detects head posture or position posture.

13. The method of claim 1 wherein one of the multiple cameras capturing an image having a highest level of attention directed toward it is selected for transmission.

14. The method of claim 1 wherein each camera is part of a device with an associated display.

15. The method of claim 14 and further comprising displaying a gallery view of attendees on the display of the device providing the selected image.

16. A machine-readable storage device having instructions for execution by a processor of a machine to cause the processor to perform operations to perform a method, the operations comprising:
detecting an attention direction of a local participant in an electronic meeting using an attention detector;
selecting one of multiple local cameras to capture images of the local participant having a position most closely associated with the detected attention direction; and
transmitting images from the selected one of the multiple cameras to remote participant devices.

17. The device of claim 16 wherein detecting the attention direction of a local participant in an electronic meeting comprises:
receiving a first image from a first local camera of the multiple local cameras in the meeting room;
receiving a second image from a second local camera of the multiple local cameras in the meeting room; and
determining which of the first and second images to which attention of the local participant is most closely directed using the attention detector.

18. The method of claim 17 wherein the second image is selected in response to the attention direction being more toward the second local camera than the first local camera for transmission to a remote participant device.

19. The device of claim 16 wherein the operations further comprise displaying a gallery view of attendees on the display of the device providing the selected image.

20. A computer implemented method comprising:
detecting an attention direction of a local participant in an electronic meeting using an attention detector;
receiving images of remote participants;
selecting one of multiple local displays for display of at least one of the images of the remote participants, the selected local display having a position most closely associated with the detected attention direction; and
displaying that at least one of the images of remote participants on the selected local display.
